(19) United States
(12) Patent Application Publication
(10) Pub. No.: US 2021/0201608 A1
(43) Pub. Date: Jul. 1, 2021

(54) SYSTEM FOR DETERRENCE OF UNHEALTHY BEHAVIOR

(71) Applicant: Avinash Patwardhan, Burke, VA (US)

(72) Inventor: Avinash Patwardhan, Burke, VA (US)

(21) Appl. No.: 16/844,623

(22) Filed: Apr. 9, 2020

Related U.S. Application Data
(60) Provisional application No. 62/955,480, filed on Dec. 31, 2019.

(51) Int. Cl. G07C 9/00; G06F 16/738; G06F 16/735

(52) U.S. Cl. CPC G07C 9/00563; G07C 9/00912; G06F 16/735; G06F 16/738; G07C 9/00571

(57) ABSTRACT

A system for deterring undesirable behavior may include a container with a sensor. The container may hold food that is prohibited for a user of the system, but not for non-users of the system. The sensor may be configured to sense information that is unique to the user. A microprocessor may receive a signal from the sensor and determine whether a user or a non-user of the system has engaged with the sensor. If the user activates the sensor, the microprocessor may provide a personalized cue to the user through an output device to deter the user from eating the prohibited food in the container.

### CROSS-REFERENCE

This application claims the benefit of U.S. Provisional Patent Application No. 62/955,480, filed Dec. 31, 2019, which is incorporated by reference herein in its entirety.

### TECHNOLOGICAL FIELD

The present invention relates to a system for deterring undesired behavior.

### BACKGROUND

Increasing loneliness, lack of human connection, and stress are contributing toward aggravating behavioral problems in humans. Some undesired behaviors include overeating, binge eating, and indulging in food beyond advisable limits. Unfortunately, current health, diet, and fitness tracking technologies are only capable of providing feedback after an undesired eating behavior has already occurred. Many technologies also incorrectly assume that humans will act rationally if provided with enough health information.

### BRIEF DESCRIPTION OF THE DRAWINGS

FIG. 1 is a schematic representation of the functional design of an embodiment of the present invention.

FIG. 2a is a schematic representation of the technological architecture of an embodiment of the present invention.

FIG. 2b is a schematic representation of the technological architecture of another embodiment of the present invention.

FIG. 3a is a schematic representation of the system being triggered when the user tries to access a prohibited food in an embodiment of the present invention.

FIG. 3b is a schematic representation of the system not being triggered when a non-user tries to access prohibited food for a user in an embodiment of the present invention.

FIG. 3c is a schematic view of the system not being triggered when a user tries to access a non-prohibited food in an embodiment of the present invention.

FIG. 4 is a schematic representation of personalizing the system in an embodiment of the present invention.

### DETAILED DESCRIPTION

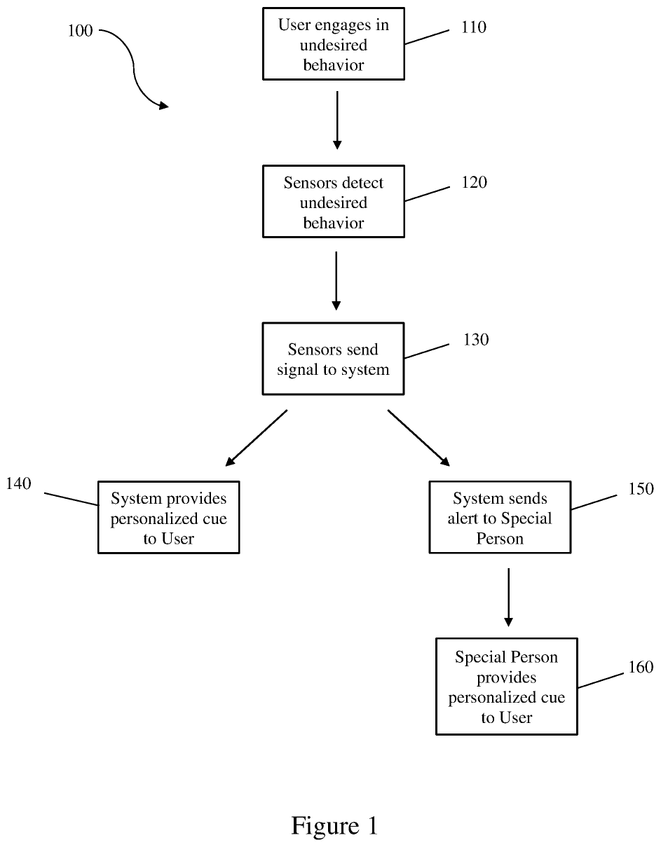

Referring now to FIG. 1, an embodiment of a functional schema 100 of the invention is shown. In an embodiment, at 110, a user of the invention engages in an undesired behavior. In an embodiment of the invention, the undesired behavior may comprise attempting to access a food that is unhealthy for the user. The undesired behavior may comprise opening a refrigerator door, opening a particular kitchen cabinet door, opening a container that contains prohibited food for the user, or going to a prohibited restaurant or location. The undesired behavior may also comprise opening a container that contains prohibited narcotics for the user. An undesired behavior may be specific to the user such that the undesired behavior is prohibited for the user but not prohibited for non-users. A food could be prohibited for the user, but not for others. Similarly, a narcotic could be prohibited for the user but not for others.

In an embodiment, at 120, one or more preinstalled sensors may be configured to detect undesired behaviors. The sensors may be associated with the objects involved with the undesirable behaviors. For example, in an embodiment of the invention, a sensor may be incorporated in a container containing food that is prohibited for the user. In an embodiment of the invention, the sensors comprise touch sensors. In other embodiments, the sensors may comprise GPS sensors, proximity sensors, weight sensors, video sensors, EKG sensors, EEG sensors, or any other sensor as understood by a person of ordinary skill in the art.

In an embodiment, at 130, the sensors send a signal to the system. In an embodiment of the invention, the sensors send the signal to the system through direct hard wiring. In other embodiments, the sensors may send the signal to the system through a wireless system (e.g., Bluetooth® or Wi-Fi) that connects further to a remote internet or cloud memory system. The system may be configured to distinguish between a sensor signal from a user and a sensor signal from a non-user.

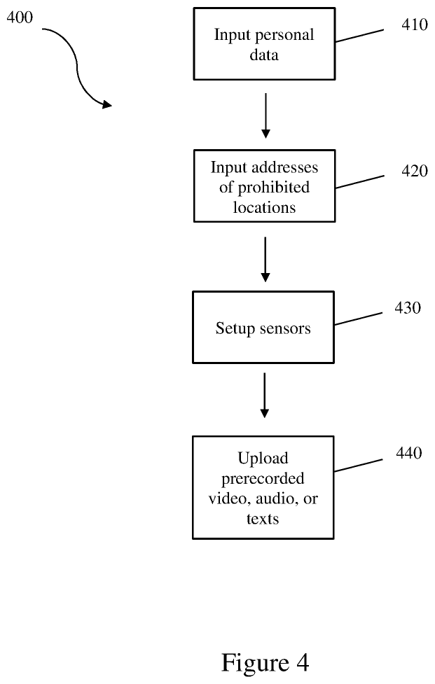

In an embodiment, at 140, when the system receives a signal from a user, the system provides a personalized cue to the user. These personalized cues, which are discussed further in connection with FIG. 4, may be pre-programmed into the system. In an embodiment, the personalized cue may comprise a pre-recorded video of an influencer—a person who the user loves, respects, or cares about. In other embodiments of the invention, the personalized cue may comprise a voice recording or a text message from an influencer to the user. The system may present the personalized cue on a display device in view of the user, such as a computer, watch, phone, tablet, wearable screen, or any other display device as understood by a person of ordinary skill in the art.

The personalized cue may comprise a general request to the user to behave better and not perform the undesired behavior. The personalized cue may create an emotional response in the user that motivates the user to change their behavior. For example, in an embodiment, the system may send a personalized cue after the user opens a container containing a prohibited food, and the personalized cue may motivate the user to not eat that prohibited food. In this way, the system acts in real-time by providing a personalized cue before the user can eat the prohibited food. The personalized cue is a cue to behavioral change.

In another embodiment, the sensors may be GPS sensors configured to determine the location of the user. Prohibited locations for the user, such as fast food restaurants, may be pre-programmed into the system so that the system may provide a personalized cue to the user if the user gets within a predetermined distance from a prohibited location. In this embodiment, the system is also working in real-time by providing the personalized cue before the user actually gets to the prohibited location.

In another embodiment, at 150, the system may send an alert to a Special Person to the user. The Special Person may be the same person as the influencer or a different person than the influencer. For example, the Special Person may be the mother of the user and the influencer may be a guru. In another embodiment, the mother of the user could be the influencer and the Special Person. The alert may be non-specific by addressing some general undesired behavior of the user, or it may be specific by detailing the exact nature of the user's behavior. The system may provide the alert to the Special Person's phone or other electronic device. In an embodiment, the alert may be sent to an app on the Special Person's phone.

In an embodiment, at 160, the Special Person provides a personalized cue—a real-time deterring cue, a request, or advice—to the user regarding their undesirable behavior. The Special Person may initiate a phone call, video call, or text message with the user by pressing a button within the app. A text message, video message, or audio message could also be automatically sent from the Special Person's phone.

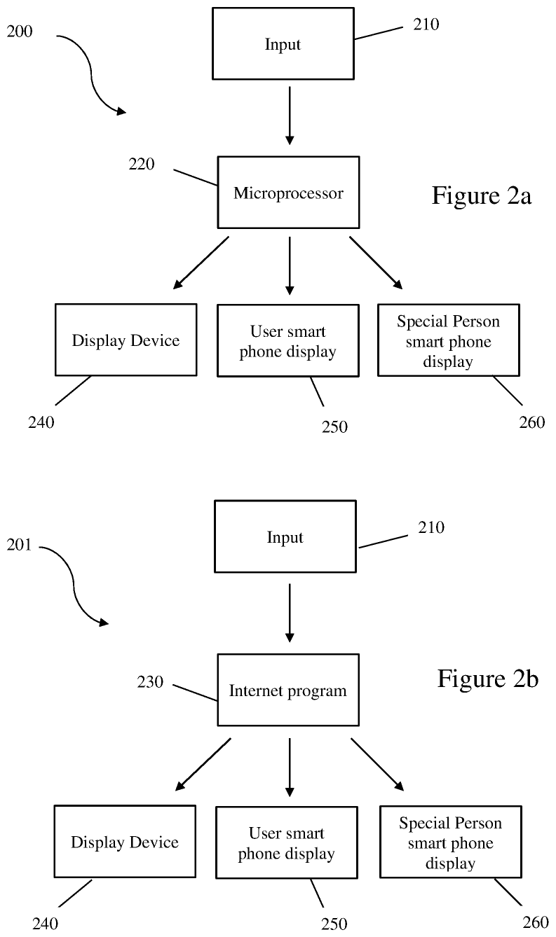

Referring now to FIG. 2a, an embodiment of the system 200 is shown. Inputs 210 may be gathered by at least one sensor. The sensors may be attached to target objects that are likely to be involved in undesirable behaviors. For example, if a jar contains cookies that are prohibited for one person in the house, but not others, a biometric touch sensor could be attached to the lid of the jar to help distinguish between the user and the non-users. In other embodiments, the sensors may comprise proximity sensors, weight sensors, video sensors, or any other sensor as understood by the person of ordinary skill in the art.

In an embodiment, the input 210, which could be a signal from a sensor, is sent to a microprocessor 220. The microprocessor 220 may be incorporated in the target object that is associated with the undesirable behavior 110. For example, a container containing prohibited food for the user may have biometric sensors 120 in the lid and a microprocessor 220 in the base. The microprocessor may also be located separately from the target objects.

The microprocessor 220 may be connected to the sensors and/or other elements of the system via Bluetooth® and/or Wi-Fi technology. The microprocessor 220 may be programmed to distinguish between a sensor signal from a user and a sensor signal from a non-user. A user's personalized data (described in the discussion of FIG. 4) may also be stored for use by the microprocessor 220. In an embodiment, when the microprocessor 220 receives a sensor signal from a user, the microprocessor 220 sends a personalized cue to a display device 240. In an embodiment, the display device 240 is hard wired to the microprocessor 220. In another embodiment, the display device 240 is connected to the microprocessor 220 via Bluetooth® and/or Wi-Fi technology.

The display device 240 may comprise a desktop computer screen, a laptop screen, a tablet, or any other display screen as understood by one of ordinary skill in the art. The display device 240 may be mounted in a place in view of where an undesired behavior may occur. For example, in an embodiment, the display device 240 may comprise a tablet mounted on top of a refrigerator. In this embodiment, the microprocessor 220 could send a personalized cue to the tablet on the refrigerator if a user attempted to open a jar in the kitchen containing prohibited food for the user.

In another embodiment, when the microprocessor 220 receives a sensor signal from a user, the microprocessor 220 sends a personalized cue to a user smart phone display 250. The user smart phone display 250 may comprise—but is not limited to—pre-recorded audio or video messages or pre-written text messages.

In another embodiment, when the microprocessor 220 receives a sensor signal from a user, the microprocessor 220 sends a personalized cue to a special person's smart phone display 260 on the phone of a person who is significant to the user. The special person then may contact the user to try to persuade the user to not perform the undesired behavior.

Referring now to FIG. 2b, in another embodiment 201, the microprocessor 220 may communicate the input 210 to an internet program 230. The internet program may be on a computer or other physical device. The internet program may also be in a remote server or cloud system. The internet program 230 may also facilitate communication with the user. For example, in an embodiment, internet program 230 may comprise a smart phone app. In this embodiment, when the internet program 230 receives a signal corresponding to an undesired behavior of the user, the smart phone app could provide a personalized cue to the user via a user smart phone display 250. The user smart phone display 250 may comprise—but is not limited to—pre-recorded audio or video messages or pre-written text messages. In another embodiment, the smart phone app could provide a special person's smart phone display 260 on the phone of a person who is significant to the user. The special person then may contact the user to try to persuade the user to not perform the undesired behavior. The smart phone app may also have the capability of initiating a phone call between the special person and the user. In another embodiment, the internet program 230 sends a personalized cue to the display device 240.

In another embodiment, the system may comprise both a microprocessor 220 and an internet program 230. The microprocessor 220 and the internet program 230 may be in either direct or wireless communication. In such an embodiment, the microprocessor 220 may receive input 210 and then communicate this to the internet program 230, which may then communicate with display device 240, smart phone display 250, and/or the Special Person's smart phone display 260 as described above.

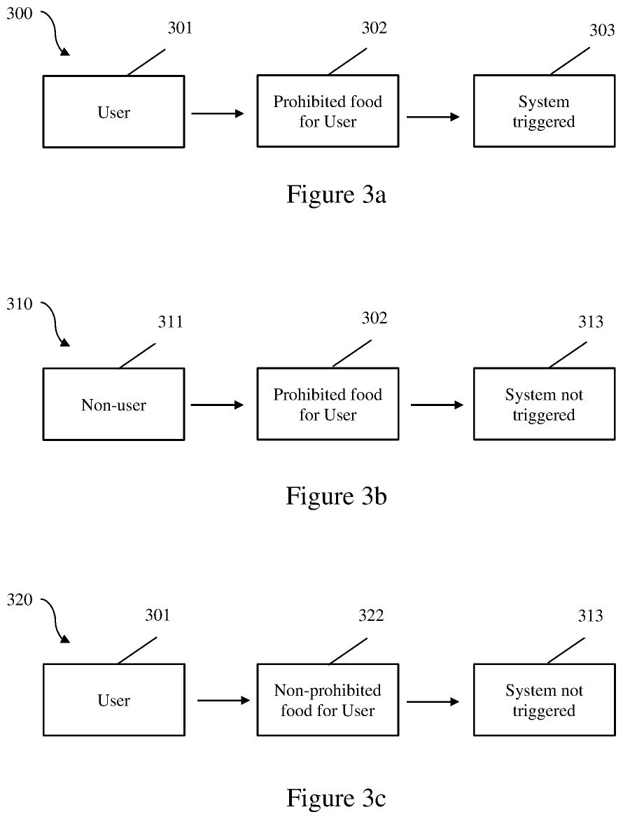

Referring now to FIG. 3a, in a first behavioral scenario 300 of an embodiment of the invention, when a user 301 attempts to access a prohibited food for the user 302, the system is triggered 303. For example, in an embodiment, brownies may be deemed prohibited for the user. The brownies may then be placed in a container that has fingerprint sensors—or any other biometric sensor—on the lid of the container. If the user 301 were to touch the container containing the brownies, then the system would trigger at 303 by sending a personalized cue to the user 301. The personalized cue may serve to dissuade the user 301 from eating the brownies.

Referring now to FIG. 3b, in a second behavioral scenario 310 of an embodiment of the invention, when a non-user 311 attempts to access a prohibited food 302 for the user, the system is not triggered. Food objects may be deemed as prohibited for the user, but not for others. For example, brownies may be prohibited for one person in a house, but not for another person. In other words, the brownies may be prohibited for the user 301 of the system, but not for the non-user 311. When the non-user 311 opens the container containing the brownies, the system does not trigger at 313.

Referring now to FIG. 3c, in a third behavioral scenario 320 of an embodiment of the invention, when a user 301 attempts to access a non-prohibited food 322 for the user, the system is not triggered at 313. Prohibited items may be identified with the sensors so that the system does not trigger when the user interacts with non-prohibited objects. For example, in an embodiment, a container containing vegetables does not have a sensor on it. Then, when the user opens the vegetable container, the system does not trigger and no cue is provided to the user.

Referring now to FIG. 4, a representation 400 of initially personalizing the system is shown according to an embodiment. The system may be configured to store various types of personalized user data. In an embodiment, at 410 the user sets up the system by inputting personal data, such as biometric data and voice recognition data. For example, the user could input their fingerprints. The user may also train the system to recognize particular orders that the user is prohibited from making at restaurants. At 420, the user may also input the addresses and/or GPS coordinates of prohibited locations, such as fast food restaurants or other eateries where the user knows that he or she frequents out of temptation. In an embodiment, these prohibited foods and locations may be changeable by the user at will. In another embodiment, only the special person, who is chosen by the user, may be able to change the prohibited foods and locations.

In an embodiment, at 430, the user sets up the sensors by incorporating them into objects or locations that are associated with undesirable behaviors. For example, if cookies are a prohibited food for the user, a fingerprint sensor could be incorporated into the lid of the cookie container, such that the user would have to contact the sensors to open the container.

At 440 the user may upload prerecorded video, audio, and/or texts to the system to serve as personalized cues that may be provided when the system detects an undesired behavior. These personalized cues may be changeable by the user at will. The user may upload messages originating from an influencer to the user, a person who they love, care about, respect, admire, follow, or emulate. In an embodiment, these messages could be from the user's spouse, life partner, religious figure, hero, spiritual guru, friend, parent, sibling, or any other special person to the user. For example, in an embodiment, the user could upload a video message of their mother speaking to them, urging them to resist indulging in the undesired behavior.

The system may be used to provide real-time personalized cues for a wide variety of undesired behaviors. The system as described herein may also be used to nudge a user to fasten a seatbelt in a moving car, nudge a user to slow down from speeding a moving car, nudge a user to wake up from sleeping while studying, nudge a user to calm down if he or she becomes anxious in a social environment, deter a user from touching an unauthorized object, or deter any other undesired behavior.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved systems for deterring undesired behavior.

Moreover, combinations of features and steps disclosed in the above detailed description may not be necessary to practice the invention in the broadest sense and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims.

What is claimed is:

1. A system comprising:
a container;
at least one sensor incorporated in the container;
a microprocessor; and
an output device;
wherein the at least one sensor is configured to sense information unique to a user, the information being sufficient to distinguish the user from a non-user; and
wherein the microprocessor is configured to:
receive a signal from the at least one sensor corresponding to an attempt by the user to access contents of the container; and
provide a personalized cue for the user through the output device, wherein the cue is provided before the access can occur.

2. The system of claim 1, further comprising an internet program, wherein the microprocessor is configured to connect with the internet program and wherein the internet program is configured to prompt a device of a special person to send the personalized cue to the user.

3. The system of claim 1, wherein the contents comprise a food item.

4. The system of claim 1, wherein the contents comprise a narcotic.

5. The system of claim 1, wherein the output device comprises a visual screen.

6. The system of claim 1, wherein the output device comprises a speaker.

7. The system of claim 5, wherein the output device is incorporated in a computing device of the user.

8. The system of claim 1, wherein the cue comprises a message that is configured to discourage the user from accessing the contents.

9. The system of claim 8, wherein the message comprises a prerecorded video from an influencer.

10. The system of claim 8, wherein the message comprises a prerecorded audio recording from an influencer.

11. The system of claim 8, wherein the message comprises a text message from an influencer.

12. The system of claim 1, wherein the output device is external to the container;
wherein the output device is incorporated in a computing device of a special person; and
wherein the cue comprises a message from the special person.

13. A system comprising:
a container;
at least one sensor incorporated in the container;
an internet program; and
an output device;
wherein the at least one sensor is configured to sense information unique to a user, the information being sufficient to distinguish the user from a non-user; and
wherein the internet program is configured to:
receive a signal from the at least one sensor corresponding to an attempt by the user to access contents of the container; and
provide a personalized cue for the user through the output device, wherein the cue is provided before the access can occur.

14. The system of claim 13, wherein the internet program comprises a smart phone app.

15. The system of claim 13, wherein the cue comprises a message configured to discourage the user from accessing the contents.

16. The system of claim 15, wherein the message comprises a prerecorded video from an influencer.

17. The system of claim 15, wherein the message comprises a prerecorded audio recording from an influencer.

18. The system of claim 15, wherein the message comprises a text message from an influencer.

19. A system comprising:
a location sensor;
a microprocessor; and
an output device;
wherein the location sensor is configured to determine a location a user; and
wherein the microprocessor is configured to:
receive a signal from the location sensor corresponding to an attempt by the user to go to a prohibited location;
store a plurality of prohibited locations for the user; and
provide a personalized cue for the user through the output device, wherein the cue is provided before the user gets to the prohibited location.

20. The system of claim 19, wherein the cue comprises a message that is configured to discourage the user from going to the prohibited location.
